(19) United States
(12) Patent Application Publication
(10) Pub. No.: US 2022/0278981 A1
(43) Pub. Date: Sep. 1, 2022

(54) Authentication System for Computer Accessing a Remote Server

(71) Applicant: Traitware, Inc., Nevada city, CA (US)

(72) Inventors: Judah L. Hardesty, Colfax, CA (US); Christopher M. Canfield, Santa Clarita, CA (US); Herbert W. Spencer, Grass Valley, CA (US)

(21) Appl. No.: 17/652,684

(22) Filed: Feb. 26, 2022

Related U.S. Application Data
(63) Continuation of application No. PCT/US2020/048031, filed on Feb. 26, 2020.
(60) Provisional application No. 62/891,686, filed on Aug. 26, 2019.

(51) Int. Cl. H04L 9/40; G06K 19/06

(52) U.S. Cl. CPC H04L 63/0853; G06K 19/06037

(57) ABSTRACT

Exemplary embodiments described herein include a password-less pluggable authentication module (PAM). Exemplary embodiments of the PAM may allow a user to log in using a smartphone as a token. The smartphone or other identifiable module electronic device may use a unique identifier of the mobile device, biometrics, and/or knowledge factors to authenticate with a remote authentication server.

### PRIORITY

This application claims priority as a continuation of International Application No. PCT/US2020/048031, published as WO2021/041566, filed Aug. 26, 2020, which claims priority to U.S. Provisional Patent Application No. 62/891,686, filed Aug. 26, 2019.

### BACKGROUND

Secure Shell (SSH) and Secure File Transfer Protocol (SFTP) are highly secure protocols used to log into a remote server. Yet despite their strengths, they are still vulnerable to some of the most basic channels of attack. The two main methods of authentication are through passwords and RSA keys. Passwords can be secure, but they will always be vulnerable to brute forcing, being forgotten, or being stolen if they are written down or stored in a password manager. This is why RSA keys are considered safer than using passwords, as the only computers that can log on are those with their private keys already stored on the remote server. If the keys match, the computer is automatically logged in without the need for any further input from the end user. However, even this method has its downfalls. If you are using a different computer that does not have its keys stored on the server, you will be unable to access the remote server. If a malicious entity gains access to your computer that has its keys on the remote server, they will be able to log onto it without needing to know your password. Due to these security risks, there is a need for a pluggable authentication module (PAM) that enables passwordless, multi-factor authentication over the secure SSH and SFTP protocols.

### SUMMARY

Exemplary embodiments described herein include a password-less pluggable authentication module (PAM). Exemplary embodiments of the PAM may allow a user to log in using a smartphone as a token. The smartphone or other identifiable module electronic device may use a unique identifier of the mobile device, biometrics, and/or knowledge factors to authenticate with a remote authentication server. Exemplary embodiments may be used to remove or minimize the possibility of an attacker guessing/stealing the password, a botnet brute forcing the credentials, or someone gaining access to the server's private keys.

In one embodiment, an OAuth token sent from the authentication server and received by the PAM installed in the host can serve as validation of an authenticated user with permission to access the host. In another embodiment, an OpenID and/or Connect ID Token may be sent from the authentication server and received by the host and inspected for information about the user logging into the host, serving also as proof that the user was authenticated and has permission to access the host.

Exemplary embodiments provided herein include the system (including hardware and/or software) and methods to send a QR text string through the SSH/SFTP channel and display it in the client terminal without transmitting a graphical image file and without the client needing to use third party graphics software. In an exemplary embodiment, user access controls may be employed by the host to grant access authorizations to an authenticated user. For example, an OpenID Connect ID Token may contain a user identifier that can be mapped to the same identifier in the host access controls. Only when a match is found can authorization to access the host be granted to that user.

### DRAWINGS

FIG. 1 illustrates an exemplary QR authentication process using the PAM according to embodiments described herein.

FIG. 2 illustrates an exemplary user interface of SSH prompt according to embodiments described herein.

FIGS. 3, 4A, and 4B illustrate exemplary user interfaces of an application according to embodiments described herein.

FIG. 5 illustrates an exemplary system configuration according to embodiments described herein.

### DETAILED DESCRIPTION

In the following description of preferred embodiments, reference is made to the accompanying drawings which form a part hereof, and in which it is shown by way of illustration specific embodiments in which the invention can be practiced. It is to be understood that other embodiments can be used and structural changes can be made without departing from the scope of the embodiments of this invention.

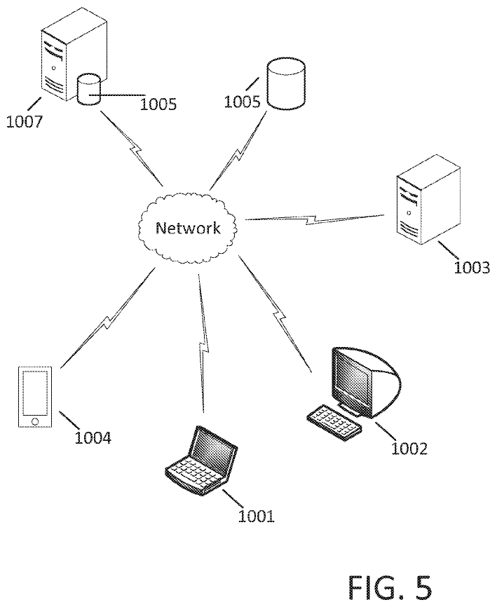

FIG. 5 illustrates exemplary embodiments of a communication platform according to embodiments described herein that can include a pluggable authentication module (PAM) on a host machine 1003 configured to communicate with an authentication server 1007 and a user terminal 1001, 1002. When a user attempts to log into a host machine 1003 from a user terminal 1001, 1002, the PAM communicates with an authentication server 1007. The authentication server 1003 creates a login session and sends a login information. The PAM is configured to receive the login information from the authentication server. The PAM, using the login information generates a QR code. The QR code is in a Unicode Transformation Format (UTF) block string so that it can be sent through an SSH tunnel and displayed as a text string. The QR code represented as UTF includes blocks of image and blocks of blanks as well as carriage return indicators so that a generated text screen according to the UTF displays a QR code. The PAM sends the QR code in UTF block string to the user terminal 1001 and/or 1002. The user terminal 1001 and/or 1002 may include a display for rendering the UTF block string and generate a QR code on a display of the user terminal. The system may also include a device recognized as associated with the user. For example, the user may have a mobile electronic device 1004. The mobile electronic device 1004 may be any mobile device configured to store an application and run the application with a processor to perform the functions described herein. In an exemplary embodiment, the application is configured to run on a mobile device 1004 and communicate with the authentication server 1007. The mobile electronic device 1004 preferably has an image sensor, and/or user input. The mobile electronic device 1004 may therefore receive an image of the QR code displayed on the user terminal 1001 and/or 1002 and communicate the image to the authentication server 1007. The communication between the host machine and user terminal with the application nm on the mobile device may include the presentation of a QR on the user terminal and a camera accessed by the application on the mobile device. The authentication server 1007 may receive the image of the QR code and authenticate the user and communicate the positive authentication to the host computer 1003. The host computer 1003 may thereafter establish or permit access to the user through the user terminal 1001 and/or 1002.

The PAM may communicate with the user terminal 1001 and/or 1002 to display to a user one or more options for authenticating the user. In an exemplary embodiment, the PAM may display to a user an option to scan a QR code or receive a push notification. The user may, through an input selection at the user terminal 1001 and/or 1002 choose between the options provided by the PAM. The PAM is configured to receive a user option to authenticate the user according to the received option. If the user selects authentication by a QR code, the PAM may generate a QR code using characters concatenated into a string which is then sent by the PAM through the encrypted SSH/SFTP tunnel and displayed in the client's terminal without the need for rendering. The authentication server is configured to receive data related to the QR code from the user's mobile electronic device, which may bypass the PAM and communicate directly between the mobile electronic device to the authentication server through the application. If the user selects authentication by a push notification, the PAM sends from the host server a push notification to the user's application running on the mobile electronic device 1004. The user may thereafter confirm their intent to be authentication by accepting or providing a user input after receiving the push notification at the mobile electronic device.

In an exemplary embodiment, the system and methods described herein create the password-less authentication of the user using SSH (Secure Shell) server access or SFTP (Secure File Transport Protocol). Exemplary embodiments of the systems and methods described herein use the PAM to implement an authentication method for an SSH or SFTP protocol that comprises passwordless multi-factor authentication and without using encryption keys stored on the user terminal 1001, 1002, or host computer 1003. The systems and methods described herein may perform the password-less authentication without storing encryption keys on the user terminal.

In an exemplary embodiment, the PAM stored and executed by the host computer 1003 may be configured to communicate with the authentication server to request a login attempt and send a client identification (ID). The PAM may be configured to receive a unique identification (UUID) number from the authentication server. The PAM may use the UUID to generate the QR code. In an exemplary embodiment, the PAM is configured to generate a QR code from the UUID in the form of a UTF-8 block string.

Exemplary embodiments of the system and method described herein may include additional and/or alternative steps and/or component features. For example, the PAM may be configured to also send a random state value during the request of the login attempt. For another example, the authentication server may be configured to send a token, timeout, and the random state value to the PAM after the QR code is authenticated by matching the UUID.

In addition to the authentication methods described in authentication patents commonly owned, the PAM is able to make use of common identity standards known in the art, such as OpenID Connect and OAuth 2.0 to facilitate the login process and provide the needed authorizations to allow the login to proceed. Exemplary embodiments of authentication patent applications used to facilitate the login process and incorporated by reference herein in their entirety: United States Patent Publication Numbers 2015/0047000; 2015/0278805; 2016/0065570; 2016/0125416; 2016/0337351; and 2019/0116177.

Exemplary embodiments of the system described herein may include a computer, computers, electronic device, or electronic devices. As used herein, the term computer(s) and/or electronic device(s) are intended to be broadly interpreted to include a variety of systems and devices including personal computers 1002, laptop computers 1002, mainframe computers, servers 1003, set top boxes, digital versatile disc (DVD) players, mobile phone 1004, tablet, smart watch, smart displays, televisions, and the like. A computer can include, for example, processors, memory components for storing data (e.g., read only memory (ROM) and/or random access memory (RAM), other storage devices, various input/output communication devices and/or modules for network interface capabilities, etc. For example, the system may include a processing unit including a memory, a processor, an analog-to- digital converter (AID), a plurality of software routines that may be stored as non-transitory, machine readable instruction on the memory and executed by the processor to perform the processes described herein. The processing unit may be based on a variety of commercially available platforms such as a personal computer, a workstation a laptop, a tablet, a mobile electronic device, or may be based on a custom platform that uses application-specific integrated circuits (ASICs) and other custom circuitry to carry out the processes described herein. Additionally, the processing unit may be coupled to one or more input/output (I/O) devices that enable a user to interface to the system. By way of example only, the processing unit may receive user inputs via a keyboard, touchscreen, mouse, scanner, button, or any other data input device and may provide graphical displays to the user via a display unit, which may be, for example, a conventional video monitor. The system may also include one or more large area networks, and/or local networks for communicating data from one or more different components of the system. The one or more electronic devices may therefore input a user interface for displaying information to a user and/or one or more input devices for receiving information from a user. The system may receive and/or display the information after communication to or from a host computer 1003 and/or a remote server 1003 or database 1005.

Exemplary embodiments described herein include using an SSH or SFTP network protocol. Exemplary embodiments include a client-server model in which a secure shell client application displays a session to a user on a user machine remote from a remote location that communicates with an SSH server or host machine in which the application is run. Exemplary embodiments use SSH or SFTP to create a secure tunnel for communication between the user machine and the remote host. The SSH or SFTP protocols may be created or authenticated using encryption key pairs stored separately on the user machine and host machine. However, exemplary embodiments may also be used without the storage of a key on the user machine.

Exemplary embodiments include a pluggable authentication module (PAM). The PAM may include hardware and software stored as machine readable code that, when executed by a processor, is configured to perform as described herein. An exemplary system may include one or more remote servers. A remote server may have storage, processor, and communication port for storing instructions and database information, communicating with a remote device, and for performing functions described herein. Exemplary remote servers may include a host machine and/or an authentication server. The system may be configured to send and receive instructions and data from and to the authentication server to and from a host machine to and from a user on a user machine. Exemplary user machines may include mobile devices, such as a smartphone, tablet, laptop, etc. or may include any computer or electronic device.

In an exemplary embodiment, the authentication server is configured to send and receive information and instructions, store information, compare information, generate decisions, and perform functions as described herein. For example, the authentication server may receive a request from a host machine to verify a login attempt. The authentication server may receive a client identification, a random state value, or other information from the host machine to initiate the authentication process. The authentication server, in response to the request for login attempt, creates a login session with the client ID and is configured to send a login attempt unique identifier and/or other information to the host machine. The UUID may be generated or sent in the form of a UTF-8 character string. The UTF-8 character string incorporating the UUID is configured to be displayed as a QR code without the need of a graphics program or hardware and without the need for rendering. Other forms of character strings besides UTF-8 can be used. The authentication server is configured to receive a scan, image, picture, or other representations of the QR code generated by the UUID and UTF-8 character string from a remote device. The authentication server may also or alternative receive information related to the QR code, such as an extracted UUID. In response to receiving the QR code or data related to the QR code, the authentication server compares and confirms the QR code matches the UUID and has available the user access rights associated with the host. In addition to receiving the QR code or data related to the QR code, the authentication server may receive a unique identifier associated with the user sending the data (as described more fully below with respect to the application). The authentication server may determine the authorization of the user relative to the host, such that the authentication server may authorizes the user, and/or provide an authorization or access level for the user. The user authorization is confirmed by sending an access token, timeout, and state from the authentication server to the host machine. Other user authorization information may also or alternatively be used to provide confirmation that the user has access to a host and/or what level of access the user may have. Additional communication between the authentication server and the host machine may be included. For example, when following Open ID Connect protocol, additional steps of exchanging an authorization code for a token may be included. The ID token may also be directly provided to the client browser. The ID token may be provided by avoiding passing the token through the browser. Exemplary embodiments of the PAM include direct server-to-server communications that bypasses a browser.

In an exemplary embodiment, the host machine is configured to send and receive information and instructions, store information, compare information, generate decisions, and perform functions as described herein. For example, the host machine may be configured to initiate the PAM and communicate with an authentication server and/or a user on a user device according to embodiments described herein. The host machine may receive a request from a user. The host machine may include a communication port that is configured to support a secure connection from a user at a user machine. The user may establish the secure connection, such as via SSH or SFTP by requesting the secure tunnel from a user machine communicating with the host machine. The host machine may be configured to send a request to an authentication server to request a login attempt to confirm authentication of the requesting user. The host machine may be configured to send the client ID associated with the user, random state value, and/or other information. The host machine is configured to receive a unique identifier (UUID) from the authentication server. The host machine is configured to generate a QR code from the UUID. The generated QR code is generated using characters such as UTF-8 block string characters such that the QR code does not need to be rendered on the receiving end. Other known encodings such as ASCII or JIS may be used when desired, with UTF-8 being the most widely used currently and the preferred method. The host machine is configured to poll the authentication server for login status after sending and/or displaying the QR code. The host machine is configured to receive through the communication portal with the authentication server the authorization code. The host machine may also be configured to send the authorization code and a secret identifier back to the authentication server to then receive an access token, timeout, and state information. The host machine may then verify the state values and permit the user to log into the host machine from their user machine. The host machine may be configured to perform the functions described herein by providing and incorporating a pluggable authentication module into the host machine that provides the communication methods and software to support the interaction between the user's mobile device, the user's terminal device, the authentication server and the host machine.

In an exemplary embodiment, the system may include an application run on the mobile device of the user for authenticating a user by communicating directly with the authentication server. The application may be configured to be stored on the mobile device of the user and when executed by the processor perform functions described herein. For example, the application may be configured to receive login credentials to open and/or launch the application. The launching of the application may be configured to identify the user. The application may also communicate with an authentication server to verify the identity of the user. The application may be configured to communicate with an electronic device configured to take images, such as a camera, and/or retrieve files containing stored images received from an electronic device, such as a memory device of stored camera images. In an exemplary embodiment, the application is configured to receive an image of an authentication screen on a user's terminal. The authentication screen may have a QR code, and the application may include image analytics for detecting the presence of the QR code within the image. The application may be configured to send the QR code, the image file of the QR code, and/or information obtained from the QR code, such as a UUID represented within the QR code to the authentication server. In addition to the QR code or data related to the QR code, the application may also be configured to send an identity of the user. The identity of the user may be in a unique identifier associated with the user and/or mobile electronic device used to store and run the application. Exemplary embodiments of the application may allow a user to log in using a smartphone as a token. The smartphone or other identifiable module electronic device may use a unique identifier of the mobile device, biometrics, and/or knowledge factors to authenticate with a remote authentication server. The application may be configured to communicate other user information and/or information used by the authentication server, as described herein.

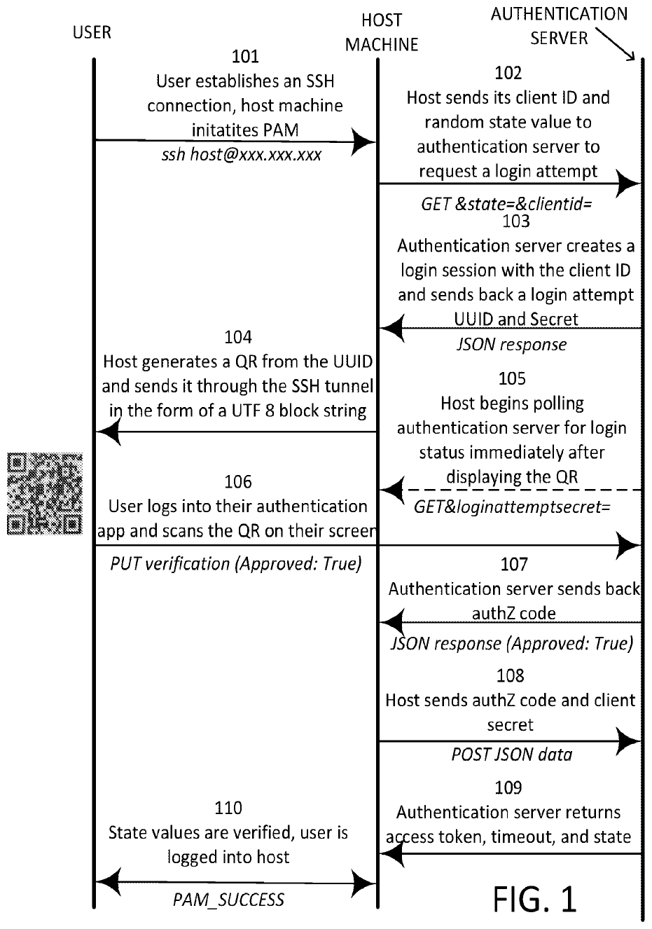

FIG. 1 illustrates an exemplary QR authentication process using the PAM. Upon a logon request via SSH or SFTP (101), the PAM module begins by sending its own client identification info along with a randomized state value (102) to an authentication server for a login attempt Unique User Identifier (UUID) and login attempt secret (103). The PAM then creates a QR code, storing the Login UUID by concatenating black and white UTF-8 block characters, along with newline characters, in the shape of a QR code. This QR code string is sent over the secure tunnel to be displayed in the client's terminal (104). The client does not need any third party rendering or graphics software to see the QR as it is simply a character string. The user then authenticates to their authentication application using either biometrics, a knowledge factor such as a password or photo selection, or other known authentication method. When the user authenticates to the application, the application may create a session id, identity token, or other unique identifier that may be used according to embodiments described herein. A user may then scan the QR presented on the client's terminal using the authenticated authentication app (106). The application may send the QR code or data related to the QR code (such as a code extracted from the QR code) and/or the unique identifier to the authentication server. The authentication server may then obtain the UUID and the identity of the user and compare against the permissions associated with the host. If that user is enabled in the authentication server to access the host server, the authentication server sends an authorization code to the host (107). The authorization code, along with the client ID and client secret are then sent back to the authentication server to request an access token (108). The authentication server verifies the information and sends back an access token, the original state value, and a timeout value (109). The system may also directly send the access token without first requiring the authorization code be communicated, thus steps 107-108 may be optional or removed from the flow diagram. The host verifies that the terminal and remote state values match, checks the access control list to ensure the authenticated user is permitted to log in, and authenticates the user (110). If the user is unable to scan the QR, they also have the option of telling the host server to send a push notification to their authentication app, which they then approve in the authentication app instead of scanning the QR.

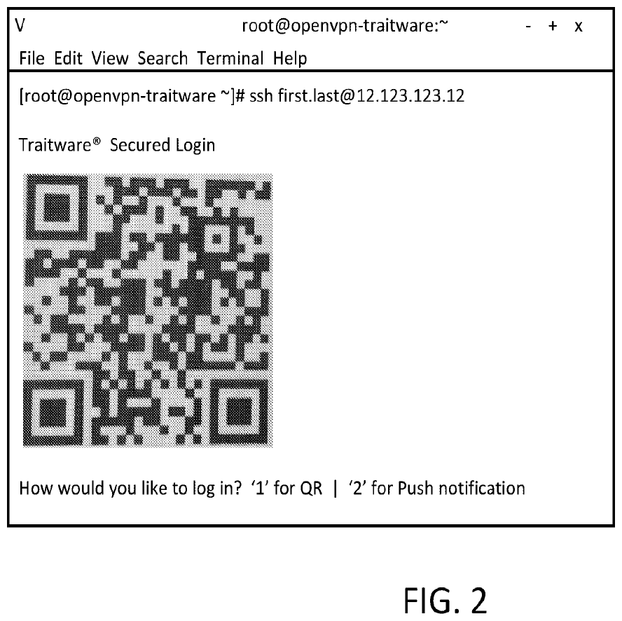

FIG. 2 illustrates an exemplary user interface of SSH prompt according to embodiments described herein. At step 104, above, after the authentication server creates a login session and provides the UUID and secret to the host machine, the host machine generates a QR code from the UUID and sends it through the SSH tunnel in the form of a UTF 8 block string. FIG. 2 illustrates an exemplary user interface at the user terminal used to display the generated QR code.

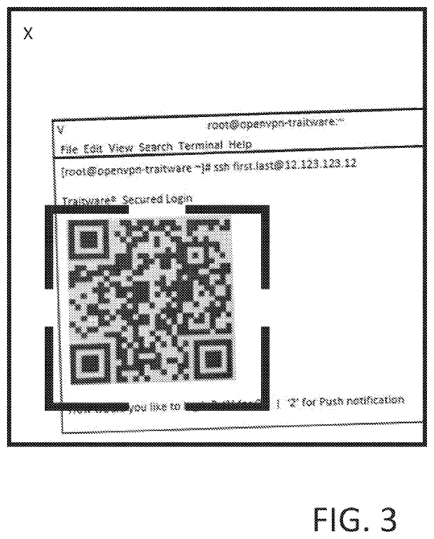

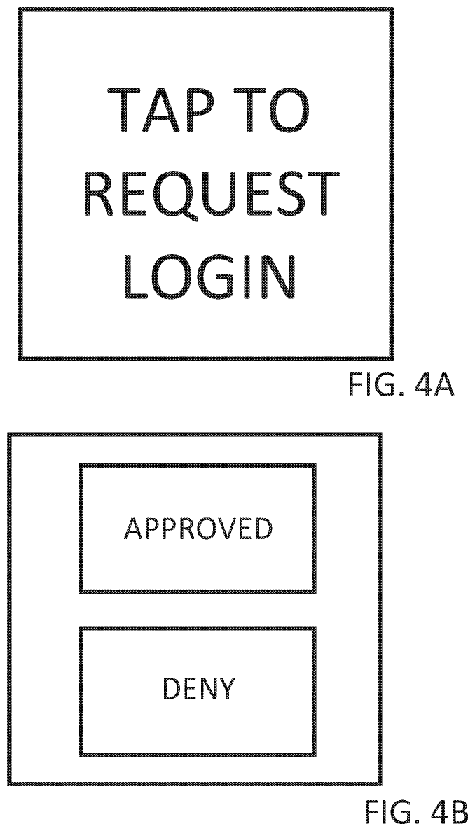

FIGS. 3, 4A, and 4B illustrate exemplary user interfaces of an application according to embodiments described herein. Once the QR code is generated on the user's terminal, the user, through their electronic mobile device may launch the authentication application and receive an image of the displayed QR code. FIG. 3 illustrates an exemplary user interface of a user's mobile electronic device. After having launched and/or logged into the authentication application saved and executed by a processor of the user's mobile electronic device, the application may display a user interface that indicates an area of an image to position the displayed QR code. The application may automatically recognize the presence of the QR code within the image, and/or may permit the user to confirm the QR is in the image frame and to send the QR code to the authentication server. For example, once the QR code is aligned within the user interface of the application, the user may touch the screen to image the QR code and send the image to the authentication server.

FIGS. 4A-4B illustrate exemplary user interfaces in which a user selects to receive a push notification to authenticate the user. In this case, the host application may display to the user at the user's terminal the QR code and/or a selection option for how to authenticate the user. As seen in FIG. 2, the user terminal displays within a text screen the QR code and an option for authentication with the QR code or by receiving a push notification. The user may enter an option according to the desired option. The user selection may be communicated back to the host computer and/or to the authentication server. If the user selects to receive a push notification, the authentication server may communicate directly with the application stored and executed on the user's mobile electronic device. The application may provide a display to the user as illustrated in FIG. 4A. The application may receive an input from the user to confirm the user's desire to confirm the log in process. As illustrated in FIG. 4B, the user may then confirm or deny the user's intent to authenticate the user and log into the host computer.

In an exemplary embodiment, the user may be required to open the application on the mobile electronic device before receiving the push notification. In an exemplary embodiment, the user may be required to open and authenticate the application on the mobile electronic device before receiving the push notification. The system may require the authentication of the application prior to the host computer communicating with the user through the SSH tunnel.

Exemplary methods and systems described herein may be used to protect the following endpoints: login, GDM, KDM, XDM, SSH, SCP, SFTP, FTP, email clients, and any PAM aware services from root access.

In an exemplary embodiment, the pluggable authentication module (PAM) may be used by an administrator at a host computer to permit remote access or authentication of a user. The administrator may download the PAM. In an exemplary embodiment, the administrator may download the PAM to a Linux machine. If the host machine is running Debian, the administrator may run the following commands to install the PAM and its dependencies:

sudo apt install libjson-c2
sudo apt install libqrencode-dev
cd pam_traitware
sudo build
sudo install-deb
sudo service sshd restart

If the host machine is using Redhat or Fedora, the administrator may use the following commands in a terminal to install the PAM and its dependencies and configure it with SELinux:

sudo yum install json-c-devel.x86_64
sudo yum install grencode-devel.x86_64
cd pam_traitware
sudo build
sudo install-rh
sudo chcon -reference /usr/lib64/security/
pam_unix/so /usr/lib64/security/pam_traitware.so
sudo setsebool -P nis_enabled on
sudo service sshd restart.

After installation, the administrator may finish setting up the configuration of the PAM. For example, the sshd configuration file may be updated with a unique client ID and client secret. Next, the administrator may add the module to the sshd config file. For example, the following line may be entered at the top of the /etc/pam.d/sshd file: auth required pam_traitware.so client_id=<yourclientid> client_secret=<yourclientsecret>.

As seen in FIG. 2, a user attempting to remotely access the host machine running the PAM over SSH or SFTP may enter the following command: ssh usemame@host. Depending on the Linux configuration, the user may receive a warning about the authenticity of the server. If the user trusts the server, the user may enter “yes” to add the IP to the list of known hosts. After creating the ssh request, the PAM communicates back to the user terminal and display the user interface, for example as illustrated in FIG. 2 including the QR code and a request about how to confirm authentication.

To securely sign in using the QR code, a user may open the application on their mobile electronic device. The user may choose a desired account and complete the authentication process to open the application. Exemplary authentications may include biometric recognition, passwords, image sequence selection, or other known log in methods. The application may then permit the user to scan the QR code. In an exemplary embodiment, once the log in request is initiated, the user may have a predetermined amount of time to authenticate with the QR code or push notification before the system times out. For example, the user may have less than five minutes to open the authentication application and image the QR code. If the session expires, then the user may need to break the session and run ssh again.

If the user selects to authenticate with the Push notification method, the user may open the application on their mobile electronic device. The user may provide authentication as described herein. In an exemplary embodiment, the authentication server will not send the push notification unless the application is open, running, and in an active session. After making the selection to receive a push notification, the user may enter an email address or other identification so the system knows where to send the push notification.

In an exemplary embodiment, the system may permit the administer to utilize geo-fencing. The user of the application and/or remote access may be limited to specific location or may exclude specific locations.

Although embodiments of this invention have been fully described with reference to the accompanying drawings, it is to be noted that various changes and modifications will become apparent to those skilled in the art. Such changes and modifications are to be understood as being included within the scope of embodiments of this invention as defined by the appended claims. Specifically, exemplary components and/or steps are described herein. Any combination of these components and/or steps may be used in any combination. For example, any component, feature, step, function, or part may be integrated, separated, sub- divided, removed, duplicated, added, moved, reordered, or used in any combination and remain within the scope of the present disclosure. Embodiments are exemplary only, and provide an illustrative combination of features, but are not limited thereto.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

1. An authentication method for an SSH or SFTP protocol that comprises passwordless multi-factor authentication without using encryption keys stored on the accessing terminal, the method comprising:
receiving a connection request from a user terminal to a host machine;
launching by the host machine launches a pluggable authentication module(PAM); generating with the PAM a QR code for display at a user terminal;
sending the QR code from the host machine to the user terminal;
receiving a confirmation at the host machine from an authentication server an indication that user terminal is authenticated; and
creating a remote communication connection between the host machine and the user terminal.

2. The method of claim 1, wherein a QR code is generated using characters concatenated into a string which is then sent through the encrypted SSH/SFTP tunnel and displayed in the client's terminal without the need for rendering.

3. The method of claim 2, wherein the QR code is generated using UTF-8 characters.

4. The method of claim 2, comprising running an authentication program on a user's mobile electronic device; scanning the QR from the user's mobile electronic device; and with the authentication program, sending data related to the QR code to the authentication server.

5. The method of claim 3, further comprising receiving from the user a user selection indicating a desire to authenticate using a push notification; running an authentication program on a user's mobile electronic device; receiving a push notification at the user's mobile electronic device; and receiving a user's input to authorization access in response to the push notification.

6. A system for authenticating a user at a user terminal, comprising:
a pluggable authentication module (PAM) on a host machine configured to communicate with an authentication server and the user terminal, wherein the system is configured to permit password-less authentication of the user to the host machine from the user terminal.

7. The system of claim 1, the PAM configured to launch upon receive of SSH (Secure Shell) server access or SFTP (Secure File Transport Protocol) to the host machine.

8. The system of claim 6, wherein the PAM is configured to receive a unique identifier from the authentication server and create a QR code from the unique identifier.

9. The system of claim 8, wherein the PAM is configured to send the QR code in the form of Unicode Transformation Format (UTF).

10. The system of claim 6, further comprising an authentication server.

11. The system of claim 10, further comprising an application configured to be stored on a user's mobile device, that when executed by a processor of the user's mobile device is configured to communicate with the authentication server.

12. The system of claim 11, wherein the PAM is configured to communicate with the authentication server to request a login attempt and send a client ID.

13. The system of claim 12, wherein the PAM is configured to receive a unique identification(UUID) number from the authentication server.

14. The system of claim 13, wherein the PAM is configured to generate a QR code from the UUID in the form of a Unicode Transformation Format (UTF)-8 block string.

15. The system of claim 13, wherein the PAM is configured to send the QR code in a form that is configured to be displayed without graphics rendering.

16. The system of claim 15, wherein the authentication server is configured to send the UUID and secret to the PAM after the request of the login attempt.

17. The system of claim 16, wherein the authentication server is configured to receive data related to the QR code from the application on the user's mobile device, bypassing the PAM.

18. The system of claim 17, wherein the application on the user's mobile device is configured to receive a scan of the QR code generated from a camera of the user's mobile device and send the scan to the authentication server with the application.

19. The system of claim 18, wherein the PAM is configured to send a random state value during the request of the login attempt.

20. The system of any preceding claim, wherein the authentication server is configured to send a token, timeout, and the random state value to the PAM after the QR code is authenticated by comparing information retrieved from the QR code against the UUID sent from the authentication server and used to generate the QR code.

21. The system of claim 20, wherein the system is configured for password-less multi-factor authentication and without using encryption keys stored on the user terminal.
